(19) United States
(12) Patent Application Publication
(10) Pub. No.: US 2026/0289094 A1
(43) Pub. Date: Sep. 24, 2026

(54) GRAMMAR-PRESERVING TEXT SALIENCY MODULATION

(71) Applicant: President and Fellows of Harvard College, Cambridge, MA (US)

(72) Inventors: Elena Leah Glassman, Boston, MA (US); Ziwei Gu, Watertown, MA (US); Kenneth Li, Allston, MA (US); Ian Anders Arawjo, Boston, MA (US); Jonathan K. Kummerfeld, Darlington (AU)

(21) Appl. No.: 19/671,497

(22) Filed: May 8, 2026

Related U.S. Application Data
(63) Continuation of application No. PCT/US24/55027, filed on Nov. 8, 2024.
(60) Provisional application No. 63/548,051, filed on Nov. 10, 2023.

(51) Int. Cl. G06F 40/166; G06F 40/117; G06F 40/284; G06F 40/30; G06F 40/40

(52) U.S. Cl. CPC G06F 40/166; G06F 40/117; G06F 40/284; G06F 40/30; G06F 40/40

(57) ABSTRACT

Some readers can find text difficult to consume. Summarization can address some of these difficulties by reducing the number of words in the text. However, summarization can omit information or context relevant to the reader, and the reader does not even know they are missing it unless they also read the entire original passage. One approach to addressing this problem is to instead modify how the original text is rendered to make important information more salient. In some embodiments, a method and corresponding system provide Grammar-Preserving Text Saliency Modulation (GP-TSM), a text rendering method able to determine which text of a passage to emphasize or de-emphasize. In some embodiments, GP-TSM employs a recursive sentence compression method to identify successive levels of detail beyond the core meaning of a passage, which are de-emphasized by rendering words in successively lighter but still legible gray text.

### CROSS-REFERENCE TO RELATED APPLICATIONS

This application is a continuation of PCT Application No. PCT/US24/55027, filed on Nov. 8, 2024, which claims the benefit of U.S. Provisional Application No. 63/548,051, filed Nov. 10, 2023. The contents of the above applications are hereby incorporated by reference in their entirety.

### GOVERNMENT SUPPORT

This invention was made with government support under 2107391 awarded by National Science Foundation (NSF). The government has certain rights in this invention.

### BACKGROUND

Some readers can find text difficult to consume because of, for example, choices by the author(s) and the reader's skills and context. For example, the author(s) may use specialized language that the reader perceives as jargon. Sentences may be long, have a complex structure, and/or have ambiguous parses, which are sometimes referred to as ‘garden-path sentences.’ The subset of the language used by the author(s) may not have a high degree of overlap with the reader's sight vocabulary (e.g., a set of words that a reader can recognize without having to decode the letters). For example, the reader may be still learning how to read in that language, or the reader may have cognitive differences or conditions that impede reading. Finally, there may be a large volume of text relative to the time and attention the reader is willing or able to set aside to read it.

### BRIEF SUMMARY

In some embodiments, a computer-implemented method for saliency-based text display includes reading a source text comprising a plurality of tokens. The method further includes providing the source text to a summarizer, the summarizer configured to summarize input text. In some embodiments, the method includes receiving from the summarizer a first summarized text. The first summarized text is a summary of the source text. The method further includes providing the first summarized text to the summarizer. The method further includes receiving from the summarizer a second summarized text. The second summarized text is a summary of the first summarized text. The method includes tagging each token of the source text based on the first and second summarized texts. The tagging includes applying a first tag to those tokens appearing in the source text but not the first or second summarized texts, applying a second tag to those tokens appearing in the source text and the first summarized text but not in the second summarized text, and, applying a third tag to those tokens appearing in the source text, the first summarized text, and the second summarized text.

In some embodiments, the summarizer is an extractive summarizer.

In some embodiments, the summarizer is a stochastic summarizer.

In some embodiments, the summarizer comprises a large language model (LLM).

In some embodiments, the method further includes providing a summarization prompt to the LLM with the source text, with the first summarized text, and with the second summarized text.

In some embodiments, the method further includes providing a summarization prompt to the LLM with the source text to obtain a plurality of candidates for the first summarized text. In some embodiments, the method further includes selecting the first summarized text from its plurality of candidates based on a quality score. In some embodiments, the quality score is based on the grammatical correctness of each of the plurality of candidates. In some embodiments, the quality score is based on the presence of paraphrasing and/or substitutions in each of the plurality of candidates. In some embodiments, the quality score is based on semantic similarity between each of the plurality of candidates and the source text. In some embodiments, the quality score is based on the length of each of the plurality of candidates.

In some embodiments, the method further includes comparing the first summarized text to the source text to identify any tokens appearing in the first summarized text but not in the source text, and removing any such tokens from the first summarized text.

In some embodiments, removing such tokens comprises reversing any paraphrasing and/or term substitution created by the summarizer.

In some embodiments, receiving a sequence of additional summarized texts from the summarizer, each summarized text in the sequence being based on its predecessor in the sequence. In some embodiments, the method further includes terminating the sequence when a summarized text in the sequence is identical to its predecessor in the sequence. In some embodiments, the method further includes terminating the sequence when a summarized text in the sequence has a quality score below a predetermined threshold.

In some embodiments, quality score is based on grammatical correctness, presence of paraphrasing and/or substitutions, response length, or semantic similarity.

In some embodiments, the method includes displaying the source text on a display. Each token in the source text includes a visual indicator of its associated tag.

In some embodiments, the visual indicator comprises one or more of: highlight opacity, highlight color, font opacity, font hue, font size, font weight, font width, font style, typeface, case, or background color. In some embodiments, the method provides one or more interactive controls on the display, the one or more interactive controls operative by a user to update the visual indicator for the first, second, or third tag.

In some embodiments, the one or more interactive controls are operable to apply the visual indicator associated with the second tag to tokens having the first tag and/or to apply the visual indicator associate with the third tag to tokens having the first or second tag.

In some embodiments, the one or more interactive controls comprise on or more of: a slider or a natural language description (e.g., a natural language description of a desired update to the visual indicator for the first, second, or third tag).

In some embodiments, a computer-implemented method for saliency-based text display includes reading a source text comprising a plurality of tokens. The method further includes providing the source text to a summarizer, where the summarizer is configured to summarize input text. The method further includes receiving from the summarizer a first summarized text. The first summarized text can be a summary of the source text. The method includes tagging each token of the source text based on the first summarized text. Tagging each token includes applying a first tag to those tokens appearing in the source text but not the first summarized text, and applying a second tag to those tokens appearing in the source text and the first summarized text.

In some embodiments, computer program product for saliency-based text display includes a computer readable storage medium having program instructions embodied therewith. The program instructions are executable by a processor to cause the processor to perform a method according to any of the above embodiments.

### BRIEF DESCRIPTION OF SEVERAL VIEWS OF THE DRAWINGS

FIG. 1A is a block diagram illustrating an example embodiment of the present method and system.

FIG. 1B is a flow diagram illustrating an example embodiment of a method employed by the present disclosure.

FIG. 2A is a diagram of a paragraph illustrating an example embodiment of the disclosed method.

FIG. 2B is a series of paragraphs illustrating an exemplary paragraph being shortened with each round of extraction.

FIGS. 3A-B are graphs illustrating an example comparison of observed task performance and task completion time in a preliminary study of embodiments of the present disclosure.

FIGS. 4A-B are graphs illustrating an example performance of participants when using embodiments of the present disclosure compared to the control conditions in the user study.

FIG. 5 is a graph illustrating an example of user's preferred ranking of embodiments of the present disclosure compared to a control.

FIG. 6 is a schematic illustrating an example of a computing node is shown.

FIG. 7 is a block diagram illustrating an example of a computer system/server in computing node is shown in the form of a general-purpose computing device.

### DETAILED DESCRIPTION OF THE INVENTION

Text summarization and/or simplification techniques can address a subset of the difficulties posed by conventional text. With summarization, the resulting text (e.g., summarized text) may be shorter, with simpler sentence structures and fewer unusual words. However, unless information is truly redundant, the result is a lossy representation of the original document, regardless of whether the process is abstractive or extractive.

The lossy nature of summarization can create a problem that is impossible for readers to notice unless they also read the original document: information judged by the summarization or simplification system/process to be insufficiently important to retain, whether it is performed by humans individually, crowd-sourced, or AI-powered, is left out of the result, even though this information may in fact be relevant to the reader, given their particular knowledge, context, preferences, values, and task. Therefore, any summarization of a text can omit information and therefore be imperfect for at least some intended readers. Personalized summarization, which summarizes text passages for specific types of users, still relies on assumptions about or coarse characterizations of users. Even with personalized summarization, many of a reader's interests and task in the moment that are not unobservable.

In some embodiments, instead of summarization/simplification of passages of text, the original text can be rendered to make more salient information more visible while still preserving the visibility of de-emphasized text. Other text rendering methods have reified a variety of computations about words and sentences within the document into a variety of modifications of the visual attributes rendering that text.

In some embodiments, a method and corresponding system combine elements of summarization and text rendering. Embodiments of the method and corresponding system are referred to as Grammar-Preserving Text Saliency Modulation (GP-TSM). In some embodiments, GP-TSM provides a computational method to determine which words in the original text to de-emphasize and by how much.

In some embodiments, GP-TSM employs a recursive sentence compression method to identify successive levels of detail beyond the core meaning of a passage. The successive levels of detail are de-emphasized by rendering words with successively less opacity for each recursive iteration of the method that determines the word(s) to be deemphasized. In other words, as the method iterates recursively, less relevant words become lighter and lighter each iteration they are deemphasized, while still making the text legible relative to the background (e.g., gray text when black text is on a white background). The lighter the text color that each word is rendered in, the earlier it was lightened in the method's recursive sentence compression process. This approach is “grammar-preserving” because the subset of each sentence, at any minimum level of opacity the reader chooses to read, remains grammatical. This supports a more natural flow of reading. A within-subjects user study (N=18) demonstrates that the final design of GP-TSM both helps readers complete non-trivial (GRE) reading comprehension tasks more efficiently and is strongly preferred over alternative text rendering methods.

In some embodiments, the present disclosure provides:
The design and implementation of GP-TSM, a recursive sentence-compression-based text rendering method that supports reading and skimming,
A formative within-subjects user study that demonstrates the value of GP-TSM's text rendering strategy—using a semi-automated sentence-compression backend, and
A summative within-subjects user study that (1) demonstrates the benefits of the fully automated GP-TSM relative to prior text rendering methods and (2) collects evidence that GP-TSM's preservation of grammar at every level of successively grayed text is key.
GP-TSM is improves on current text summarization and current text rendering methods intended for reading, skimming, and information retrieval support.

Natural language documents are a large part of people's everyday lives, and reading them can require non-trivial mental effort. In particular, long, complicated sentences can be hard to understand. Studies from the American Press Institute show that when a document's average sentence length is 14 words, readers understand more than 90% of what they are reading. When a sentence reaches 43 words, comprehension drops to less than 10%. None the less, long complex sentences remain a common occurrence. For example, recent education research articles written in English had an average sentence length of 24.7 words, similar to news text and biomedical text, which average 24.8 and 24.5 words per sentence respectively in standard corpora.

Given the cognitive effort reading requires, readers frequently resort to skimming, which is a rapid, selective, and non-linear form of reading. Eye tracking studies validate that such behavior is extremely common. However, multiple studies have suggested a significant trade-off between reading speed and comprehension. In addition, skimming, a skill that takes time to learn and employ effectively, requires strategy and attention. In particular, when skimming in unfamiliar contexts, readers can struggle to stay focused, miss key information, and lack confidence in their understanding. Studies have shown that the comprehension of important and unimportant information from a text was equally degraded by an increase in reading rate.

Examples of text summarization can be either extractive or abstractive. Extractive summarization selects a set of text segments from the original document(s) and combines the segments to form a summary. In text summation, the summary is entirely composed of verbatim content (i.e., words have been removed from the text, but none have been added). Some extractive systems select a set of sentences for the summary, but other extractive systems compress or merged the sentences that are selected. A range of modeling and learning methods may be employed. A problem with this extractive approach is that it can be difficult or impossible to concisely capture meaning while only using verbatim content.

In contrast, abstractive summarization generates novel sentences to capture the essence of the content. Abstractive summarization can be more flexible, concise, and human-readable. Historically, extractive summarization has been more accurate and generated more coherent text. With the increased use of natural language generation using large language models (LLMs), abstractive summarization has become more effective, however.

While traditional extractive summarization predominantly involves selecting whole sentences, compressive summarization aims to select the shortest subsequence of words within a sentence that yields an informative and grammatical sentence. This framework allows for a more concise representation of the original content while retaining the essence of its meaning. Various techniques have been developed within this framework.

GP-TSM modulates the saliency of words in the original text so that users can easily bypass certain words during skimming while maintaining an uninterrupted reading flow. In some embodiments, the method provides a recursive process that generates multiple-nested levels of compression, in which information is captured at varying degrees of detail. In contrast, while there has recently been some work on generating a set of summaries that vary in detail, it has been abstractive, with content at each level that does not overlap.

A range of technologies may be applied to summarization, from traditional NLP techniques to large language models (LLMs) and even crowd-powered methodologies. The recent improvements in LLMs have significantly increased the quality of summarization methods, including compressive summarization. The summaries they produce are better in terms of coherence, grammaticality, and coverage of critical content. There are a variety of systems that employ summarization within their enhanced reading environments. Specifically, many systems add abstractive and/or extractive summaries to give the reader additional, shorter, possibly simpler text that augments the original content.

For example, Paper Plain uses AI models to generate abstractive summaries of each section of a medical paper which is intended to make the science literature more approachable to healthcare consumers. Marvista, a human-AI collaborative reading tool, employs an extractive strategy in the “before reading” phase and automatically chooses a summative subset of text for users based on their time budget and questions they want to answer. Marvista then uses AI-generated abstractive summaries to help readers review and recall important information from articles in the “after reading” phase. A service called newsLens describes a quote-extraction based summary using entity extraction and dependency trees to complement news headlines and represent potentially important details from the rest of the article.

However, regardless of the method used, both abstractive and extractive summarization can introduce significant changes in semantic meaning, e.g., through misinterpretation of the input or unintended meanings of the output. To mitigate this lossy nature of summarization methods, embodiments of the present disclosure approach supporting reading and skimming by adjusting the way text is rendered while keeping all text available to the user to enable recovery from AI errors.

### Text Rendering Modulation Methods

Modulating text saliency is a form of textual information representation. This technique modifies the visual attributes of text to promote words of interest and guide readers' attention, making pertinent information more perceptible and thereby enhancing comprehension and the user experience. The term “saliency” can be defined as a “bottom-up, stimulus-driven perceptual quality which makes some items stand out from their neighbors,” and is also used in contexts such as augmented reality, computer vision, and cognitive science.

A range of visual strategies may be used to promote text saliency in digital reading environments. Different types of textual data, including the literal text itself, can be mapped to visual attributes, and then drawn as marks in a layout. Varied use of typography, or font attributes such as bold, italic, font size and case, on an individual word level may be employed to convey information in a way that is intended to facilitate skimming and text analysis. Such methods can use multiple visual attributes of text simultaneously rather than just text color, and no controlled studies are presented that evaluate their effectiveness. Font attributes of individual words can be used to create thumbnails by retaining a readable font size of interesting text while shrinking less interesting text.

Character-level saliency and animation techniques can be used to enhance navigating the revision history of textual documents.

Color as a tool for emphasis and differentiation may be employed. For example, a color-coded system may be used to label different types of (entire) sentences in scientific articles. Sentence highlighting at various saliencies may be used, where the saliency of the highlight corresponds to the position of the sentence in a list ranked from most to least predicted importance. The sentiment of specific sentences or paragraphs of a document can be conveyed by rendering them with different visual attributes (i.e., using background color to represent polarity of emotion; italics for sentences predicted to be subjective; underlines for “emotion” words (such as green or red depending on predicted emotion); font weight to render predicted intense or diminutive words; and font size and spacing modulated by predicted reading grade level).

In some embodiments of the present disclosure, the method and corresponding system of GP-TSM compute what text to de-emphasize, and display the resulting text. The method's recursive sentence compression approach enables the visual distinction of multiple nested grammatical subsets of sentences. As a result, the novel method of computation also presents a new scope of visual attribute modulation.

Computational methods can determine text saliency. For example, words may be weighted based on English language word frequency or specific domain vocabularies. Such word-frequency-based methods are optimized for highlighting unique words for information retrieval, but do not account for the core meanings of a text document or the relationship between words within the same sentence, like GP-TSM does. A neural network based AI model may be used to rank sentences according to predicted importance. While GP-TSM uses an AI model, its model is used for a different purpose: performing sentence compression recursively.

Many systems use text rendering modulation methods, highlights, and/or annotations to visualize their analyses of text in-place. For example, SCIM helps readers skim scientific articles by highlighting sentences about different key aspects of a paper using different colors, with a density configurable by readers. VARIFOCALREADER automatically annotates and highlights text segments in the detail layer and uses the opacity of the annotation highlight to indicate the confidence value from its support-vector-machine-based active learning component. TextViewer, built for literary scholars, renders text with colored underlines to denote text that has been tagged, with the saturation value of the underline corresponding to the absolute value of the tag weight.

Theoretic and empirical studies of different visual enhancement techniques have also been carried out. In some embodiments, the method and corresponding system of GP-TSM employ saliency modulation as a form of “contextual cuing” to arm users with “incidental knowledge about global context,” which the readers can harness to better assign visual attention and memory. Various highlighting techniques direct attention to highlighted words or phrases, but they do not necessarily accelerate reading because, in practice, users may still need to read the often long, complicated text context around highlights to understand the highlights.

However, such findings are not predictive of the impact of GP-TSM because the computational method GP-TSM employs is fundamentally different in its approach. In some embodiments, GP-TSM users can indeed achieve reading comprehension tasks with heightened efficiency, at least in the context of answering GRE Long Passages reading comprehension questions. GP-TSM identifies and renders multiple nested levels of detail, which each make grammatical sense and preserve as much semantic meaning as possible.

### GP-TSM

In some embodiments, GP-TSM is a text rendering tool that alleviates some of the cognitive demands of reading, skimming, or performing information retrieval on natural language documents or passages-particularly those with long, complicated sentences—without compromising the integrity of the original content. In some embodiments, GP-TSM meets one or more of the following criteria:
a. Remain faithful to the original text. In some embodiments, the system does not automatically reword or add new words or phrases to the original text. It preserves the original text, while rendering it in a way that aids reading, skimming, or information retrieval.
b. Integrate seamlessly into existing reading experiences. In some embodiments, the system complements existing digital reading workflows that people are accustomed to. It provides all the functionalities in the same view of the reader, thereby minimizing the overhead of mode and context switching.
c. Support reading at multiple levels of detail. In some embodiments, the system helps users navigate the full complexity of a text by letting the users shift focus seamlessly between different levels of semantic coverage, or granularity, from the big picture to the fine details. The system allows users to decide how much detail they want to read and in case they desire a more granular/detailed/closer read, enables them to do so without requiring any extra action on the user's part. For example, the user does not have to perform any action to reveal text deemed to be details. Lower levels of detail are not hidden from the user both to save the user from having to take an action to reveal them and so that users do not have to guess whether they care enough about any hidden detail to decide whether to take that action to reveal them.
d. Support skimming without interrupting flow. In some embodiments, the system improves skimming of text while minimizing the impact on the user's natural reading flow. The system avoids presenting users with salient text that is unparsable as a coherent thought. In other words, the system should deemphasize phrases or sentence fragments, as opposed to a complete sentence which is more likely to be salient or have salient components.
e. Enable the reader to (a) notice and (b) easily recover from automated decisions they disagree with. In some embodiments, if the system makes an automated judgement call that is inappropriate given the reader's values, preferences, knowledge, context, or task, the reader should be able to recognize that without taking any additional action beyond looking at the interface itself. The reader can proceed without being negatively affected it by simply reading the deemphasized text. In summary systems, hidden details—that are critical to a reader but judged to be nonsalient and hidden by an AI—cannot be noticed by virtue of them being hidden, unless the user knows to take an action to reveal them and discover that they disagreed with the AI's judgement.

TABLE 1

| | Scope of | | | Extractive |
|---|---|---|---|---|
| Text | Attribute | Interaction | Summary | Summarization |
| Attribute | Modification | Technique | Scope | model |
| Highlight opacity | Character | Clicking (a button) | Sentence | TF-IDF |
| Highlight color | Word | Clicking (a carousel) | Paragraph | Constituency tree |
| Font opacity | Phrase | Dragging a slider | Document | analysis |
| Font hue | Nested | handle | Corpus | Dependency tree |
| Font size | grammatical | Gesturing (pinch to | | analysis |
| Font weight | subset(s) of the | zoom) | | Linear programming |
| Font width | sentence | Pressing keys on a | | Latent semantic |
| Oblique | Entire sentence | keyboard | | analysis |
| Typeface | | Scrolling with a | | Autoencoder |
| Underline | | mouse | | Large Language |
| Case | | Swiping on a touch | | Model |
| | | screen | | |
| Background color | | Toggling | | |
| | | rendering | | |
| | | on/off | | |

Table 1 illustrates the design space that was explored for interfaces that support reading, skimming, and/or information retrieval, including five main parameters and alternative values for each parameter. In some embodiments, the bolded items describe the design choices of GP-TSM. In other words, in some embodiments, the system employs a text attribute of font opacity to emphasize and deemphasize words, modifies nested grammatical subsets of the sentence for scope of attribute modification, employs toggling rendering on and off as an interaction technique, summarizes at the scope of a paragraph, and employs a large language model as an extractive summarization model. In some embodiments, any of the text attributes, scopes of attribute modification, interaction techniques, summary scopes, and extractive summarization models can be employed. In some embodiments, any combination of the text attributes, scopes of attribute modification, interaction techniques, summary scopes, and extractive summarization models can be employed.

### Text Attribute to Modify.

In some embodiments, the GP-TSM modulates opacity. For black text on a white background, this is equivalent to choosing font colors on a gray scale. Other alternatives like background color or stylistic indicators such as italics, typefaces, and underlines be visually distracting compared to opacity. Modulating opacity allows for a graded emphasis on text without disrupting the visual cohesion of the paragraph, offering a smooth reading experience. Since it is a continuous feature, it can be modulated to varying degrees to differentiate multiple levels of detail as well.

Opacity modulation is an intuitive mapping of meaning for users. For example, with black text on a white background, lighter text that has less contrast with the background denotes detail, while darker text signifies criticality. Regardless of the text and background colors, modulating opacity allows the text containing the details to have less and less contrast with the background behind it—giving the user the feeling of “fading away” the text or moving the text back “into the background.” Altering other font attributes, such as font hue or width, but found that their meaning was less clear to participants in early pilot studies.

The system ensures that even the least opaque text is still legible. In other words, the least opaque text is consistent with guidelines on contrast ratios provided by WCAG (Web Content Accessibility Guidelines), so that words that the computational method deems to be details are not hidden. If they were hidden, they would be unnoticeable by a reader who needed them given their context.

Deciding to use opacity instead of similar attributes, like font weight or bolding presented challenges that had to be overcome. Bold text inherently demands attention, drawing the reader's eye immediately to those words or phrases. While this is effective for emphasizing certain sections, it is contradictory to a goal of de-emphasizing text or suggesting skipping portions of the text. Moreover, bold typeface can be visually overpowering and might create visual fatigue over extended reading periods, especially in documents with frequent emphasis changes. On the other hand, fading out text provides a more subtle indication of detail level without aggressively diverting the reader's focus. The less obtrusive fading method (e.g., by reducing opacity of less salient text rather than increasing opacity/boldness of relevant text) enables a more balanced and smooth reading flow if the computational method chosen makes relatively “smooth” predictions across sequential words in a sentence.

### Scope of Attribute Modification.

In some examples, chosen scope of attribution modification can be characterized as word-level, but words or even phrases are not considered independently outside of their sentence by embodiments of present method and system. Instead, the attribute of grammatical subset(s) of each sentence are modified, which reveal levels successively smaller detail identified during its computational recursive sentence compression process. This is aligned with the design goal of supporting skimming without interrupting flow. One can skim at any minimum level of opacity (skipping over the words between levels of opacity) and still be reading coherent sentences that preserve as much of the semantic meaning of the original as possible.

### Interaction Techniques.

In some embodiments, the system and method can be implemented on desktop computers. While some embodiments can further be implemented on mobile devices, studies have found improved memory and better performance when people read on desktop computers compared with mobile devices. Desktop environments may offer a more conducive setting for extensive reading, particularly for longer and more complex documents because a larger screen displays more information in a single view without requiring frequent scrolling or zooming. In some embodiments, the system and method can employ desktop interactions using the mouse and keyboard. However, in some embodiments, alternative interactions, such as swiping and gesturing for a mobile device or table, can be employed as well.

Examples of user input includes desktop interactive techniques such as sliders, carousels, and mouse scrolling mechanisms for transitioning between hiding/revealing different levels of information granularity. In some embodiments, the features of GP-TSM can be activated or deactivated by keyboard or mouse. In some embodiments, a simple activation and deactivation interface ensures seamless integration into existing reading workflows and allows readers to notice and recover from automated decisions they disagree with. Hiding information interferes with the latter goal, and preliminary studies indicated that the choice interfered with the former goal as well. These preliminary studies, which included a mouse-scrolling feature, suggested that such interactive elements could inadvertently disrupt reading, diverting user attention from the primary task of comprehension. Other interaction methods can overcomplicate the system, which intimidated some users due to the steeper learning curve. By designing a system that automatically determines and displays text saliency without demanding active user adjustments, the system reduces the cognitive load required for reading, an already demanding task.

### Computation Scope.

When determining the scope of text on which to perform computation to determine which units of text to modify, some embodiments of the system employ a scope of paragraph-level over sentence- or document-level. The use of this scope is motivated by formative empirical observations when prototyping at each level. When considering each sentence in isolation, relatively little text within the sentence was de-emphasized because the system attempts to constraint the core meaning of the un-faded text to be very close to the original text—in this case, the sentence itself.

However, many paragraphs have an overarching single topic, especially in certain kinds of writing like non-fiction, and using the paragraph as the scope of computation provides more leeway to de-emphasize parts of sentences (and sometimes, eventually even entire sentences) while still not straying too far from the overall core meaning of their containing paragraph, as captured computationally in GP-TSM by LLMs. In other words, a typical paragraph is large enough to yield significant amounts of text for de-emphasis, but small enough to have a single coherent theme that is the focus of summarization.

Choosing something larger than paragraphs, such as entire documents, poses the challenge of the computational method making even larger choices about what to de-emphasize that a given reader might disagree with; in other words, it would be deciding on a larger, more noticeable scale which set of ideas are most critical to retain un-faded. In some embodiments, the method and corresponding system of GP-TSM—no matter what scale of decisions an AI is making—allows readers to notice and, without taking any additional action, recover from differences of ‘opinion’ between the user and the AI. The larger the degree that the user perceives the AI to be “getting it wrong,” the more likely the user may turn GP-TSM off altogether. Therefore, larger level scopes of analysis (e.g., chapters, sections, entire articles, entire books) can be performed by GP-TSM but may not provide the best user experience. In some embodiments, the user (e.g., in a settings window) can modify the scope of analysis, even if it is not the default setting.

### Extractive Summarization Method.

Extractive summarization can be performed a variety of ways. Classical syntax-based methods were examined for GP-TSM, but parser errors and the limited flexibility of pruning parse trees led to output that was ungrammatical and/or missing key words. A dependency parser and shortening the sentence by removing subtrees based on depth and dependency type frequently removed important contextual information such as key adjectives and noun phrases. Many extractive summarization methods also failed to achieve the desired results as they could not be used to generate the multi-level recursive extractive summary. These observations led us to explore the potential of an LLM-based approach, given their recent improvements.

### Overview of the GP-TSM System.

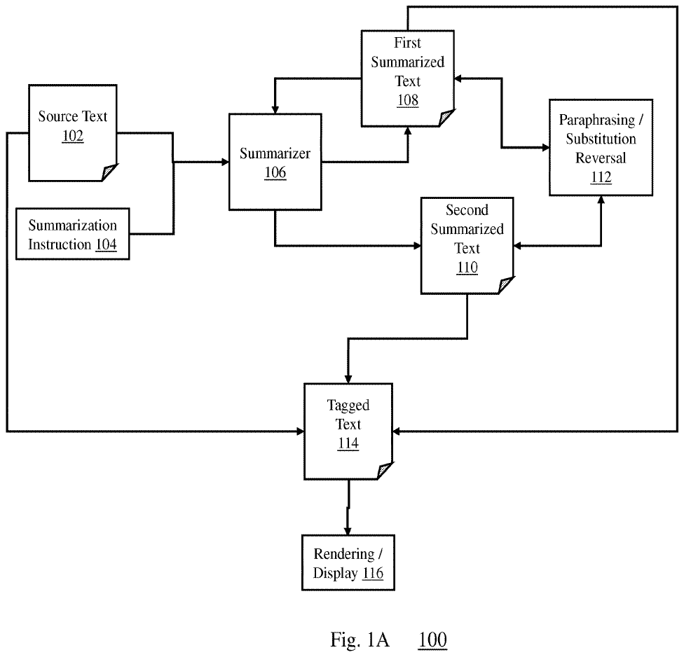

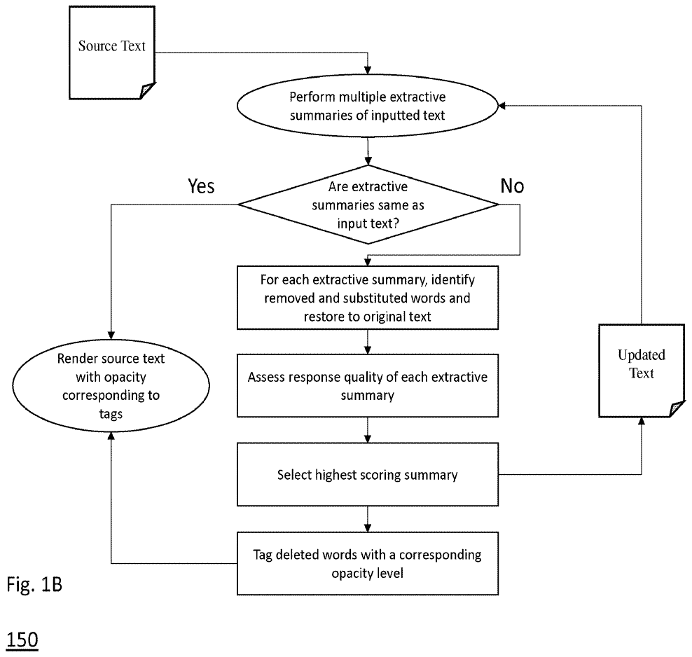

FIG. 1A is a block diagram 100 illustrating an example embodiment of the present method and system. A source text 102 and summarization instruction 104 are provided to a summarizer 106. In some embodiments, the summarizer 106 is a large language model (LLM). In some embodiments, the summarization instruction 104 is a prompt to perform an extractive summary on the source text 102. The summarizer 106 acts on the source text 102 in accordance with the summarization instruction 104 (e.g., performing an extractive summary) and provides a first summarized text 108. In some embodiments, the first summarized text 108 can be a plurality of first summarized texts that are subsequently ranked.

A paraphrasing/substitution reversal module 112 analyzes the first summarized text 108 and compares it to the source text 102. The paraphrasing/substitution removal module 112 then reverts any identified word substitutions or additions to the text inputted to the summarizer 106 in that iteration of the method (in this iteration, the source text 102). The output of the paraphrasing/substitution removal module 106 then becomes (e.g., overwrites, is a new version of) the first summarized text 112. In some embodiments, a heuristic evaluator (not shown) (e.g., heuristic evaluator module, heuristic evaluator software) assesses response quality. In some embodiments, the response quality is based on any combination of four scores: (1) semantic fidelity, (2) response length, (3) paraphrasing frequency, and (4) grammatical correctness.

A difference detector (not shown) compares the first summarized text 108 and the source text 102 and generates a tagged text, the tagged text 114 indicating which words were omitted from the source text 102 in that iteration.

The summarizer then performs the same exercise on the first summarized text 108 and summarization instruction 104, thereby generating a second summarized text 110 from the content of the first summarized text 108. In some embodiments, the second summarized text 110 can be a plurality of second summarized texts that are subsequently ranked.

A paraphrasing/substitution reversal module 112 analyzes the second summarized text 110 and compares it to the first summarized text 108. The paraphrasing/substitution removal module then reverts any identified word substitutions or additions to the text inputted to the summarizer 106 in that iteration of the method (in this iteration, the first summarized text 108). The output of the paraphrasing/substitution removal module then becomes (e.g., overwrites, is a new version of) the second summarized text 110. In some embodiments, a heuristic evaluator (not shown) (e.g., heuristic evaluator module, heuristic evaluator software) assesses response quality. In some embodiments, the response quality is based on any combination of four scores: (1) semantic fidelity, (2) response length, (3) paraphrasing frequency, and (4) grammatical correctness.

A difference detector (not shown) compares the second summarized text 110 and the source text 108 and generates a tagged text 114, the tagged text 114 indicating which words were omitted from the source text 102 in that iteration. In some embodiments, the difference detector (not shown) compares the second summarized text 110 and the first summarized text 108, thereby generating a tagged text that indicates which words were omitted in the second iteration.

In some embodiments, the iterations can repeat (e.g., for a third summarized text (not shown), fourth summarized text (not shown), etc.) until there are no changes in the summarized texts in two consecutive iterations. On that condition, the system concludes further summarization rounds and renders/displays the source text using the tagged texts to determine the level of opacity for each word.

FIG. 1B is a flow diagram 150 illustrating an example embodiment of a method employed by the present disclosure. In a first iteration, the method performs a multiple extractive summaries of inputted text, the inputted text being a source text. The method than determines whether the extractive summary is the same as the input text (e.g., the source text). If the extractive summary is the same as the source text, the method then renders the source text with opacity corresponding to tags. In this first iteration, this would result as the text being rendered with no opacity changes.

If the extractive summary is not the same as the source text, the method identifies removed and substituted words and restores those words in the extractive summary to have the original words of the input text. The method then assess the response quality of each extractive summary (e.g., a combination of all or some of the four scores of (1) semantic fidelity, (2) response length, (3) paraphrasing frequency, and (4) grammatical correctness)). The method then selects a highest scoring summary. The method then tags deleted words of the selected summary with a corresponding opacity level (e.g., iteration count). The method further provides the extracted summary as an updated text to a next iteration of the method.

In the next iteration, the method performs a multiple extractive summaries of inputted text, the inputted text being the updated text. The method than determines whether the extractive summary is the same as the input text (e.g., the updated text). If the extractive summary is the same as the updated text, the method then renders the source text with opacity corresponding to tags. In this next iteration, this would result as at least one level of text having a different level of opacity.

If the extractive summary is not the same as the updated text, the method identifies removed and substituted words and restores those words in the extractive summary to have the original words of the input text. The method then assesses the response quality of each extractive summary (e.g., a combination of all or some of the four scores of (1) semantic fidelity, (2) response length, (3) paraphrasing frequency, and (4) grammatical correctness)). The method then selects a highest scoring summary. The method then tags deleted words of the selected summary with a corresponding opacity level (e.g., iteration count). The method further provides the extracted summary as an updated text to a next iteration of the method.

The method continues to iterate until the extractive summary is the same as the inputted text to the summarizer. As the method iterates, the tags indicate an iteration of the method that the word of the text was deleted. For example, a word deleted in the first round (e.g., iteration one) is considered least salient. Upon rendering, a word with that tag will have a low opacity. In contrast, in an example where the method runs six times, a word deleted in the six round (e.g., iteration six) will be given higher opacity, but not as much opacity as the non-deleted words of the text.

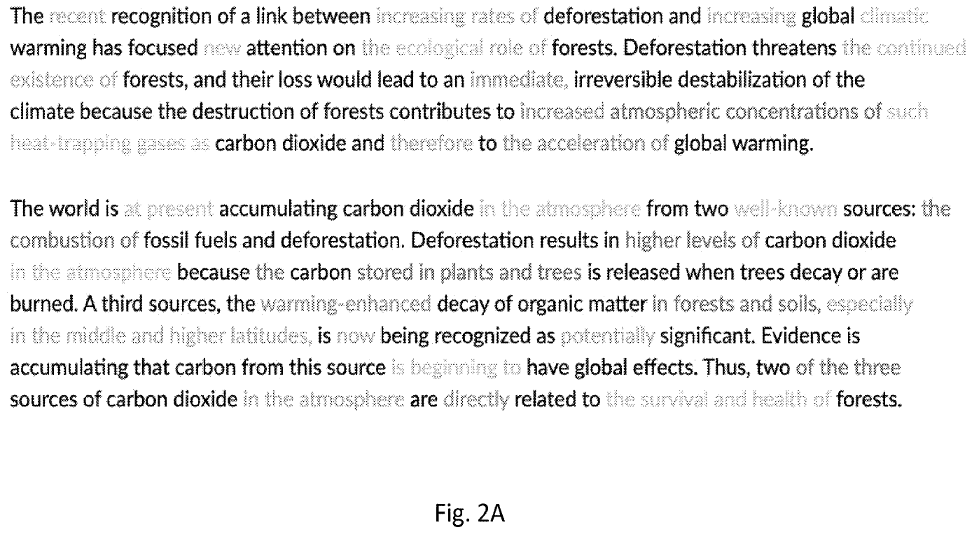

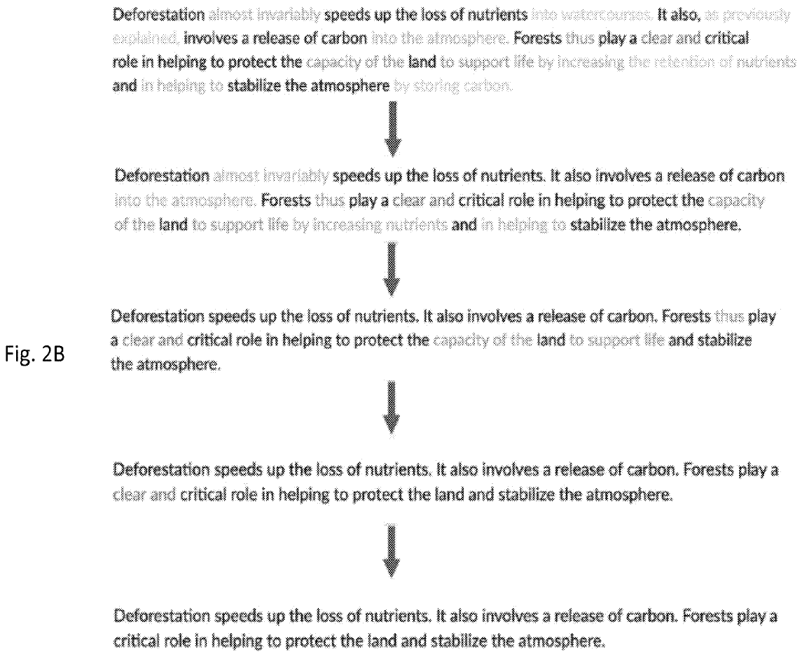

In some embodiments, the method and corresponding system of GP-TSM re-renders plain text at multiple levels of opacity in a user interface. These levels of opacity reveal multiple successive recursive levels of grammatically correct detail within each sentence of each paragraph. The re-rendering is produced by successively shortening the passage across multiple iterations, as illustrated by FIGS. 2A-B. Words deleted in the first round are deemed the least important, and therefore given the least opacity. Words deleted in the second round are deemed slightly more meaningful and appear more opaque, successively until the last round. Words that are never removed remain in full color. In other words, the GP-TSM visualization displays some text that is not entirely relevant to the core meaning of a sentence as appears lighter than relatively more important text. When a sentence is long, complicated, and full of irrelevant continuations and phrases that add little to the overall meaning, the opacity of certain words and phrases is reduced based on the outcome of successive rounds of shortening. When a sentence is simple, words remain displayed as opaque to resemble their salience.

### Method Workflow.

FIG. 2A is a diagram illustrating an example embodiment of the disclosed method. FIG. 2A is an illustration of the output of the system having darker words/higher opacity for more relevant words, and progressively less opacity for each less relevant word or clause. In some embodiments, producing the GP-TSM visualization for a given passage ensures that every level of extraction remains both grammatical and sufficiently close to the core meaning of a passage, for some designer-set threshold and notion of closeness. In some embodiments, the approach employs a large language model (LLM). In one example, OpenAI's GPT4 can be employed with the following prompt:
“Delete spans of words or phrases from the following paragraph that don't contribute much to its meaning, but keep readability:
{paragraph}
Please do not add any new words or change words, only delete words.”

FIG. 2B is a series of paragraphs illustrating an exemplary paragraph being shortened with each round of extraction. The top paragraph includes the full source text inputted into the system and as rendered with modifying the opacity for less salient words. Each successive paragraph illustrates a round of modified extractive summarization (e.g., summarization without removing or substituting words) performed by the present method. While the present system does not display each shortened paragraph, they are illustrated here to show the progression of recursive shortening that the method performs. As can be seen by reading each successive sentence, each level stays grammatical after shortening. The increasingly faded text at each level before the final most concise extractive summary show what will be removed at each level; the most faded text at the top level was removed first. The top level being rendered in this figure is the only rendering of this process that readers see, while the lower levels show words being removed from the sentence at each iteration as performed by an actual extractive summarization method.

In some embodiments, an LLM-based approach has been shown by pilots to be fairly successful within the studies reported. While leveraging an LLM is the computational method behind the recursive sentence compression approach, simply asking an LLM to do this is insufficient on its own for three reasons: (1) sometimes it adds or changes words, (2) the quality of the output varies, and (3) it only provides one set of words to de-emphasize. The present approach provides further methods beyond the LLM query to address these insufficiencies.

### Undoing LLM-Inserted Words and Substitutions.

In some embodiments, a SequenceMatcher identifies words that the LLM has added or changed. These added or changed words represent rewrites and are hence not allowed by embodiments of the disclosed system or method because those rewrites mean the user is no longer seeing the original paragraph. These substitutions are replaced with the original words from the paragraph, the insertions are removed, and the result is referred to as the post-reversion LLM response.

### Improving Output Quality.

Whenever the LLM generates a shortened paragraph, it may fall short of fulfilling its prompt. For example, removing words can lead to grammatical errors, only adding or substituting words, or removing words in a way that changes the meaning of the text significantly. To address this, a request to shorten the LLM-shortened paragraph is performed multiple times (e.g., 8 times, in one example) using the same prompt. Empirically, at least one resulting paragraph is sufficiently high quality for GP-TSM to continue with.

In some embodiments, to automatically identify the highest quality response, each response is provided to a custom heuristic evaluator. In some embodiments, the heuristic evaluator (e.g., heuristic evaluator module, heuristic evaluator software) assesses response quality based on a combination of four scores: (1) semantic fidelity, (2) response length, (3) paraphrasing frequency, and (4) grammatical correctness.

The semantic fidelity score is a similarity between the original (e.g., pre-summarization) paragraph and the shortened paragraph, calculated using a cosine similarity of their respective embeddings produced by sentence transformers.

The length score measures how closely the length of the response aligns with a preset optimal length. In some embodiments, the preset optimal length can be 85% of the previous level's length. However, a person of ordinary skill in the art can appreciate that other optimal lengths can be employed that are less than or greater than 85%. In some embodiments, the user can adjust the preset optimal length.

The paraphrasing metric quantifies an inverse of detected insertions and substitutions, as determined by a SequenceMatcher, before such insertions and substitutions were automatically reverted.

The grammatical correctness score is generated by prompting GPT4 to evaluate the syntax of the response after reversion using a discrete scale. In some embodiments, the discrete scale can be: 0 for ‘bad grammar’, 0.5 for ‘moderately grammatical’, and 1 for ‘grammatically correct’, however, other values for the scale can be employed. The prompt employed was:
“Score the following paragraph by how grammatical it is.
{paragraph}
Answer A for grammatically correct, B for moderately grammatical, and C for bad grammar. Only respond with one letter.”

An A was mapped to a 1, a B was mapped to 0.5, and a C was mapped to 0. All four scores are normalized to range (e.g., from 0 to 1). These scores are combined (e.g., via averaging) to produce an overall quality measure of each individual post-reversion LLM-shortened paragraph (e.g., one of the eight for every recursive round). The method then selects the highest scoring option, discards the rest of the options, and proceeds to the next level, which takes as input the highest-scoring LLM output that was just chosen.

### Identifying Multiple Levels of Relevance.

For each paragraph in the given passage, the system performs multiple rounds of LLM-powered extractive paragraph summaries, each round on the results of the previous round, to identify multiple levels of criticality within each sentence of each paragraph. In each round, the methods described above to (a) request a number of responses (e.g., 8 responses) from GPT4, (b) resolve word addition and substitution, and (c) select the best option using the evaluator. In the first round, the input is the entire paragraph. In subsequent rounds, the input is the best output from the previous round.

In some embodiments, recursive extractive summarization process stops when the LLM “refuses” to cut any words from the summary chosen for the “deepest” level reached so far. This stopping criterion is used because the LLM often returns the paragraph unchanged if it cannot find additional words to delete. This is a better stopping criterion than any other heuristic because it is sensitive to the complexity of the original paragraph. More complex paragraphs can accommodate more recursive levels of summarization, while simpler paragraphs may have few words that can be cut and still maintain grammaticality. In other words, the recursive process stops when none of the eight requested LLM summarized paragraphs return a summary with any deleted words.

### Implementation.

In some embodiments, the interface is implemented as a Flask application that is configured to make API calls to OpenAI's GPT4 model. In some embodiments, the interface is a web application.

### User Studies.

Embodiments of GP-TSM were evaluated in two studies-a preliminary user study of the effectiveness of the visualization given a partially automated backend and a summative user study that measures the impact of the GP-TSM when fully automated. In every user study, every interface being tested was referred to by an arbitrarily assigned color (e.g., “reader-green” or “reader-blue,” as others have done previously).

### Preliminary User Study.

To understand whether the GP-TSM visualization improves reading comprehension and the reading experience, a preliminary user study with 18 participants involving a semi-automated human-supervised version of GP-TSM was conducted. In this phase, the purpose was to gauge the efficacy of modulating text opacity over nested grammatical subsets of sentences while setting aside concerns about the quality of the backend. In other words, the goal was to verify that grammar-preserving text saliency modulation helps, if the eventual fully automated AI backend can perform as well as the human-in-the-loop (partially automated) AI backend used in this study.

The decision to employ such a partially automated approach stems from emerging practices in prototyping AI and NLP systems, which argue that, given the significant effort and time required to verify output quality of a production-ready AI-powered system, techniques that employ human-verified AI outputs should be used first before deciding whether to implement the actual AI system.

The preliminary study evaluates the exact same visualization as the eventual fully automated GP-TSM system, but instead of automatically choosing the best response from GPT4, a human inspector picked the response they believed was best (e.g., had the least rephrasing) and then manually reverted any rephrases in the chosen response. When necessary, the human inspector also edited the response to fix ungrammaticality.

One additional interactive variant included as an extra condition for comparison in this preliminary study is a slider or mouse wheel affordance for hiding text below a certain level of opacity and is referred to as interactive granularity or interactive compression. This feature partially violates the design goals because, even though it is technically feasible to reveal hidden levels of detail by moving the mouse wheel, slider, or other user inference element, when the user notices decisions they disagree with, they may change the granularity and hide some of the original text.

Testing was performed to answer the following questions:
a. How does the GP-TSM visualization affect people in reading and skimming?
b. What is the user experience like when using the GP-TSM visualization for reading and skimming?
c. What kinds of value, if any, does interactive granularity control provide for readers?

In summary, to study these questions, a within-subjects design was conducted with three conditions: HITL-GP-TSM (Human-in-the-Loop GP-TSM), HITL-GP-TSM-INTERACTIVE (Human-in-the-Loop GP-TSM with interactive granularity), and CONTROL. HITL-GP-TSM is a partially automated GP-TSM visualization, with only a simple toggle to turn it on and off, HITL-GP-TSM-INTERACTIVE added interactive granularity to HITL-GP-TSM, and CONTROL simply presented the original plain text. All conditions used the same font and font size (Lato, 14 pt).

### Participants.

The study had 18 participants (8 female and 10 male; 8 between 19-24 years of age and 10 between 25-34 years of age) from university mailing lists at an R1 university in North America. Participants received a $20 Amazon gift card as compensation. The screen criteria were: “Participants need to be fluent in English and over 18 years of age.” Participants' self-reported English reading proficiency was relatively high (asked to rate proficiency out of ten, with ten highest: M=8.38 (SD=1.37).

### Procedure, Conditions, and Measures.

The study was split into the following parts: informed consent, three sequential reading tasks, and a final survey. Prior to starting each task, each participant went through a short walk-through of the task and affordances of the assigned interface condition. Each participant was given up to 10 minutes to complete each reading task, and asked to complete the task as fast as they could to the best of their ability. The entire study took about 60 minutes.

Each reading task was completed in a separate interface condition (HITL-GP-TSM, HITL-GP-TSM-INTERACTIVE, or CONTROL). Participants encountered each interface and each reading task exactly once, and both the reading task order and condition order was counterbalanced across participants. Specifically, a partial counterbalancing of passages to conditions was performed that ensured each passage appeared the same number of times in each condition, and in each condition in each position. This counterbalancing reduces the effect of any substantial differences in difficulty between passages, however, the test sampled half of an entire counterbalancing set. Therefore, subsequent analysis described in the results uses a mixed effects model. The passages in the test are referred to as R1, R2, and R3.

The study used Graduate Record Examinations (GRE) passages and reading comprehension questions as the tasks, specifically the ‘Long Passages’ subsections of the GRE Verbal Reasoning section, each with exactly four questions. They are a relatively standardized measure of reading comprehension. They are specifically designed to require close reading, measure participants' understanding of the text, are standardized to have similar difficulty, and all questions count equally towards the final score.

After each reading task, participants completed a questionnaire to record their reflections on their experience and perceived difficulty of the task in the assigned condition. Questions included an overall rating of the interface and NASA TLX survey questions, and two questions about self-rated task performance. The HITL-GP-TSM-INTERACTIVE and HITL-GP-TSM conditions had four additional questions about the visualization; and HITL-GP-TSM-INTERACTIVE had another two additional questions about the interactive granularity. After finishing the reading tasks, participants were asked to fill out a post-study survey to indicate their preferences across all three conditions and provide further qualitative feedback. Post-study surveys are provided in the Appendix.

### User Study of the Fully Automated GP-TSM.

After implementing an embodiment of a fully automated version of GP-TSM, a user study with 18 participants evaluated the efficacy of the fully automated static GP-TSM, using a similar study format. This time, the study investigated the following questions:
a. How does the fully automated GP-TSM affect reading comprehension? Reading experience?
b. How does GP-TSM compare to the nearest previously published text saliency modulation method for reading and skimming?
c. Is the rendering of multiple nested grammatical subsets of sentences resulting from recursive extractive summarization intelligible to users?
d. What is the impact of preserving the grammaticality of each nested subset of each sentence in GP-TSM provide on users, relative to a version of GP-TSM that does not preserve grammaticality?

To answer these questions, the preliminary study design is modified in the following ways:

First, the interactive granularity condition was replaced with WF-TSM, as a replacement for a text saliency modulation method for reading and skimming. WF-TSM also uses a graying visualization that uses a word-frequency-based method to determine text saliency. More specifically, in WF-TSM, words that appear less frequently are more opaque, and more frequent words are less opaque. The percentage of words that are less than fully opaque in WF-TSM is comparable to that in the GP-TSM condition, so any effects are not due to how many words are grayed out, but which words are grayed out.

Second, an additional study component is added to the end, in which users experience and are asked to reflect on reading the same passage in two different conditions: GP-TSM and a new control, NGP-TSM. NGP-TSMis GP-TSM with grammaticality constraints removed from both places within its workflow: the LLM prompt and the LLM response evaluator. In this study, the phrase but keep readability in the GP-TSM prompt was replaced with Don't worry about grammar, and the grammaticality score was removed from the evaluation heuristic, and hence un-enforced. In other words, GP-TSM enforces grammaticality at every minimum level of opacity and NGP-TSM does not. In this study, asking participants to compare them quantifies the criticality of grammaticality enforcement to the success of GP-TSM.

The modified, non-grammar preserving extractive summarization prompt, in its entirety, was:
“Delete spans of words or phrases from the following
paragraph that don't contribute much to its meaning. Don't worry about grammar:
{paragraph}
Please do not add any new words or change words, only delete words.”

After participants of the study finished all the reading tasks and the post-all-reading-tasks survey that were present in both the preliminary user study and this user study, they participated in a 5-minute survey where they were presented with a view of the same passage rendered twice, side by side, once with GP-TSM and once with NGP-TSM. The study counterbalanced the presentation order of the two passages to ensure that each appeared on the left and right sides an equal number of times. The study asked whether participants could discern any differences between the two and, if so, to specify those differences. Additionally, the study asked their preference between the two visualizations. This part of the study was exploratory and preliminary, meant to give us an indication of the value grammar preservation adds to the system.

All other aspects, including the control condition, the chosen reading passages and the counterbalancing of conditions, passages, and their respective pairings, remained consistent with the preliminary study.

While exact timing information was not recorded, the fully automated GP-TSM took approximately 2-3 minutes to compute and render the GRE Long Passages texts for each reading task. This time did not affect participants' task time because the results were cached before the participants activity in the study began.

### Participants.

This study had 18 participants (7 self-identified as female, 10 as male, and 1 as non-binary; 7 were between 18-24 years of age, 10 between 25-34 years of age, and 1 between 35-44 years of age) from university mailing lists at an R1 university in North America. Participants received a $25 Amazon gift card as compensation. Participants' self-reported English reading proficiency was relatively high, when asked to rate proficiency out of ten, with ten highest: M=8.59 (SD=1.71).

### Results.

### Preliminary User Study.

Reading task results were analyzed with a three-factor (repeated measures) ANOVA mixed effects model; specifically, investigating each dependent variable on fixed factors Condition, Passage, and Order (e.g., the position of the task, first, second, or third in the sequence) and any interaction effects among these factors, controlling for the random factor of Participant. Satterthwaite's method was used to estimate denominator degrees of freedom. Pairwise comparison with Tukey's HSD (with α=0.05) was conducted between each of the three conditions and three passages. Hereafter, these methods are referred to as ANOVA and Tukey's test, respectively.

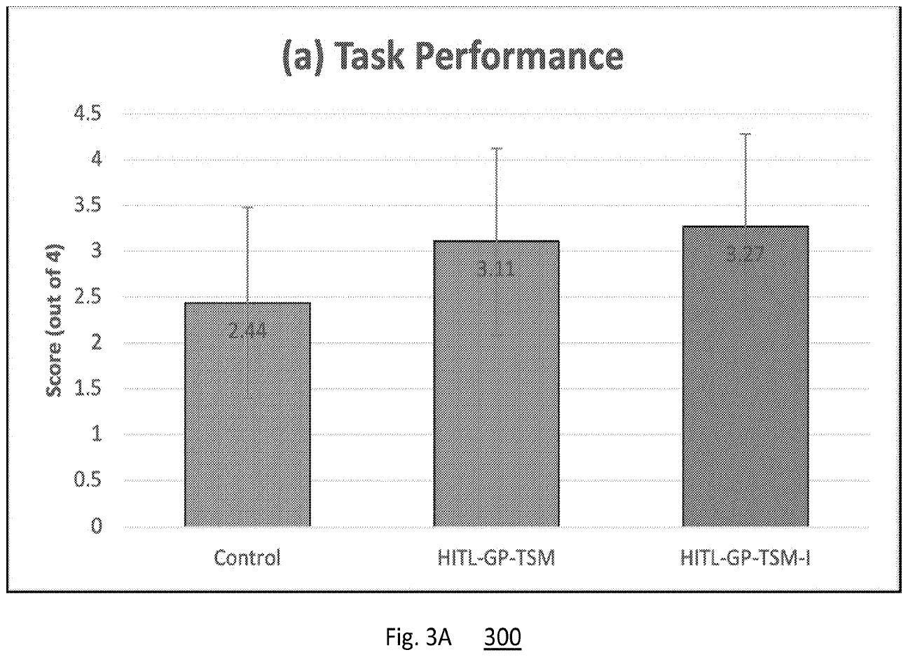

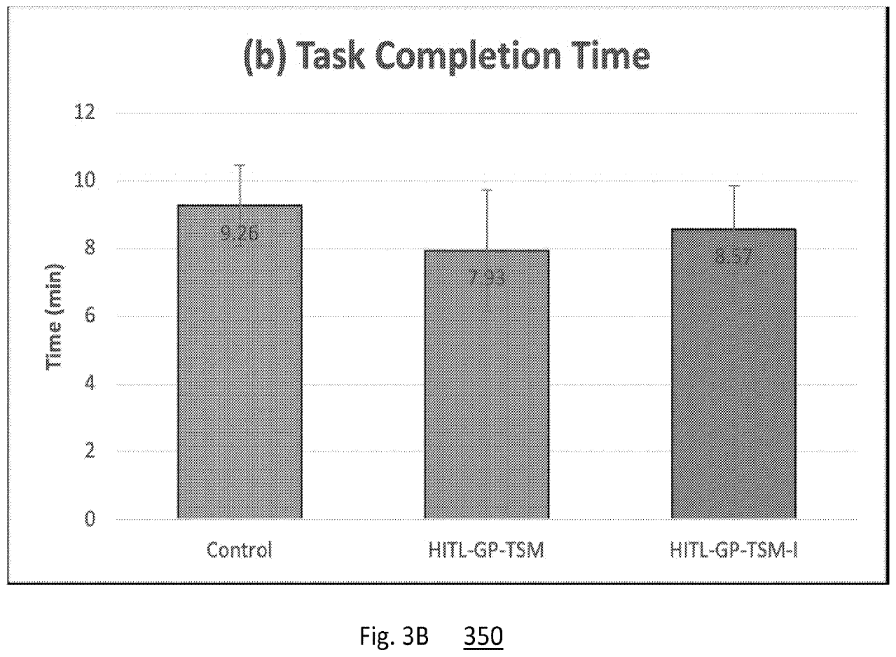

ANOVA analysis shows a significant main effect of Condition on reading comprehension scores (p=0.03, F_{2,11.3}=4.81). Using Tukey's test, compared to participants using CONTROL, participants with access to interactive granularity (HITL-GP-TSM-INTERACTIVE) scored significantly better on reading comprehension questions (p=0.047)—answering approximately three fourths of an additional question correctly out of four. Participants in HITL-GP-TSM were not far behind, though the difference was not significant—they answered approximately half an additional answer correctly out of four, relative to participants in CONTROL. FIGS. 3A-B illustrates this concept.

ANOVA analysis also found a significant main effect of Condition on time spent completing each reading task (p=0.022, F_{2,10.6}=5.52). Participants using HITL-GP-TSM completed their reading comprehension questions in only 7.9 min (SD=1.9 min) on average, which Tukey's test shows was significantly faster (p=0.029) than participants in CONTROL, which completed their reading comprehension questions, on average, 1.4 minutes later, at 9.3 min (SD=1.2 min). Other tests do not reach significance.

Participants using HITL-GP-TSM-INTERACTIVE were not significantly faster than CONTROL, but this may have been due to effects that would ultimately fade with additional use. For example, some participants spent some of their time playing with the interactive elements, “trying out different widgets,” and “figuring out what exactly the mouse and sliders do.”

FIGS. 3A-B are graphs illustrating an example comparison of observed task performance and task completion time of the HITL-GP-TSM-INTERACTIVE, HITL-GP-TSM, and CONTROL implementations in the preliminary study. FIG. 3A illustrates that, in the preliminary user study, HITL-GP-TSM-INTERACTIVE resulted in significantly better performance on the reading comprehension task than CONTROL—on the order of nearly an entire reading comprehension question out of a total of four, though participants in the HITL-GP-TSM condition were not far behind. FIG. 3B illustrates that in the HITL-GP-TSM condition, participants completed reading comprehension tasks significantly faster than when using the CONTROL.

Participants generally expressed a preference for the two GP-TSM conditions over CONTROL. ANOVA analysis shows a significant main effect of Condition on participants' answers to the questions in Table 2, which were asked after each reading task. Tukey's test shows that HITL-GP-TSM received significantly more positive ratings from participants than CONTROL in 5 out of the 9 questions that were asked in both conditions, for overall experience, how mentally demanding the task was in that condition, how hurried or rushed they felt, ability to recognize key points in the passage and ability to recognize how key points were supported by additional detail. HITL-GP-TSM-INTERACTIVE only received significantly more positive ratings from participants compared to CONTROL on the question about overall experience.

TABLE 2

| Question Statements | GP-TSM | GP-TSM-1 | Control |
|---|---|---|---|
| How would you rate your overall | 5.61 (1.24)* | 5.44 (3.25)* | 4.06 (1.21) |
| experience in this interface? | | | |
| How mentally demanding was the task? (lower is better) | 4.33 (1.37)* | 4.56 (1.46) | 5.5 (1.29) |
| How physically demanding was the task? (lower is better) | 1.94 (1.35) | 2.28 (1.41) | 2.67 (1.71) |
| How hurried or rushed was the pace of the task? (lower is better) | 2.72 (1.45)* | 3.17 (1.62) | 4.28 (1.67) |
| How successful do you think you were in | 5.11 (1.41) | 5.33 (1.14) | 4.56 (1.50) |
| accomplishing the task? | | | |
| How hard did you have to work to accomplish | 3.94 (1.21) | 4.17 (1.20) | 4.94 (1.43) |
| your level of performance? (lower is better) | | | |
| How insecure, discouraged, irritated, stressed, | 2.67 (1.50) | 3.08 (1.55) | 3.78 (1.90) |
| and annoyed were you during the task? (lower is better) | | | |
| I could recognize the key points in the passage. | 6.11 (1.02)* | 5.89 (1.08) | 5.0 (1.37) |
| I could recognize how the key points are supported | 5.89 (1.13)* | 5.5 (1.29) | 4.78 (1.56) |
| by additional detail in the passage. | | | |
| The systems's choice of what to gray out and what | 5.61 (1.42) | 5.78 (3.31) | N/A |
| to keep at full font weight made sense to me. | | | |
| I think I know why certain words were lighter than others. | 5.67 (1.24) | 5.83 (1.25) | N/A |
| I found it helpful that certain words were lighter than others. | 5.44 (1.20) | 5.67 (1.28) | N/A |
| The different levels of gray helped | 5.28 (1.23) | 5.22 (1.35) | N/A |
| me see the relationships between different parts of sentences. | | | |

Table 2 illustrates statistics of scores in the survey after each reading task. For brevity, the shorthand of GP-TSM for HITL-GP-TSM and GP-TSM-I for HITL-GP-TSM-INTERACTIVE are used. Participants were asked to rate their agreement with statements related to their reading experience on a 7-point Likert scale from “Strongly Disagree” (1) to “Strongly Agree” (7). The questions 2 through 7 (and their scales) were adapted from the NASA Task Load Index. Statistics in columns 2, 3, and 4 are presented in the form of mean (standard deviation). ANOVA analysis shows a significant main effect of Condition on participants' answers. Statistically significant (p<0.05) differences compared with CONTROL through Tukey's HSD tests are marked with a *. For the last four statements, which concern the text opacity visualization and thus do not apply to the control condition, significance was calculated based on just the two remaining experimental conditions.

These preliminary results verify the usability and helpfulness of the GP-TSM visualization in supporting reading comprehension, suggesting that it would be worthwhile to implement and evaluate a fully automated version of GP-TSM.

The benefits of interactive granularity were less clear cut. While the HITL-GP-TSM-INTERACTIVE condition also results in significantly better performances and reading experience than CONTROL, the difference between HITL-GP-TSM-INTERACTIVE and HITL-GP-TSM is not significant. Moreover, only HITL-GP-TSM results in both significantly faster task completion and significantly lower perceived difficulty. Therefore, in some embodiments, the feature of interactive is not or does not have to be present.

### Fully Automated GP-TSM.

This study used same statistical analysis process as in the preliminary study to analyze the reading task results and Likert survey questions.

### GRE Question Scores and Task Times.

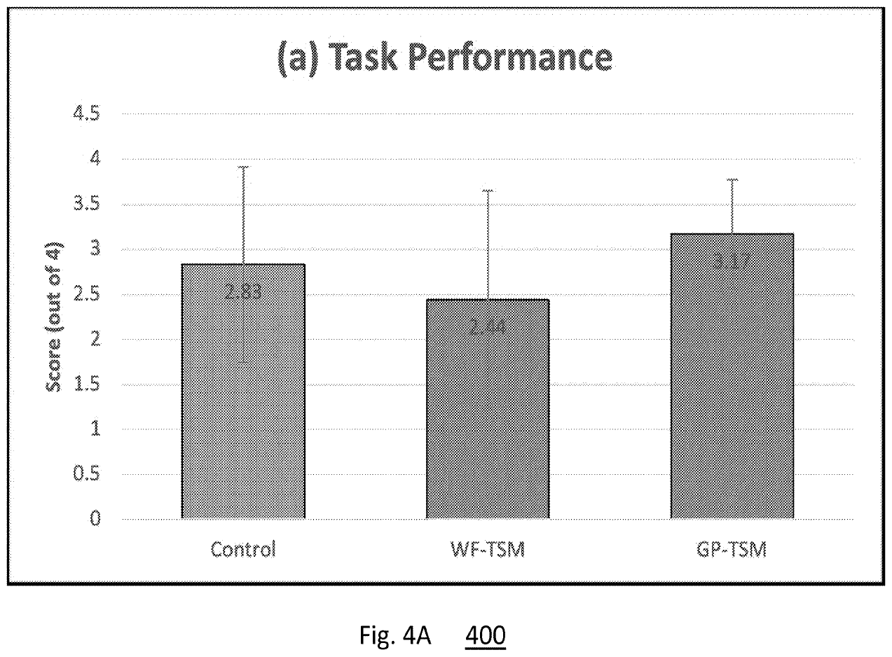

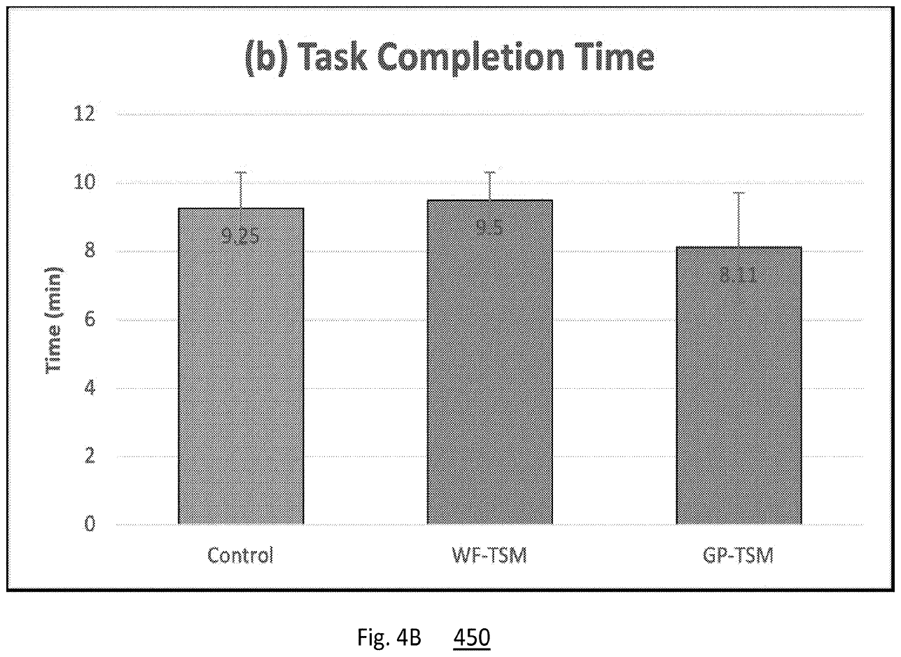

FIGS. 4A-B are graphs illustrating participant performance in the reading comprehension task when using GP-TSM compared to the control conditions in the user study. The graphs, described further below, illustrated that participants performed better and faster when using GP-TSM.

FIG. 4A is a graph illustrating that participants performed significantly better when using GP-TSM compared to CONTROL, and when using CONTROL compared to WF-TSM. FIG. 4B is a graph illustrating that participants also completed tasks significantly faster when using GP-TSM, compared to both WF-TSM and CONTROL. Specifically, ANOVA analysis shows a significant main effect of Condition on reading comprehension scores (p=0.02, F_{2,11.3}=4.79), and Tukey's test shows that participants earned significantly higher scores when using GP-TSM compared to participants using CONTROL (p=0.021)—answering about half a question more correctly out of four questions, on average. Tukey's test also shows that WF-TSM was significantly worse than CONTROL (p=0.045): participants using CONTROL answered about half a question more correctly out of four questions than those using WF-TSM.

ANOVA analysis shows a significant main effect of Condition on task times while achieving these reading comprehension scores (p=0.0026, F_{2,10.6}=6.72). Tukey's test shows that, when using GP-TSM, it took participants, on average 8 min 7 s to complete the reading task (SD=1 min 36 s), which was, on average, about a minute faster than when using the CONTROL (M=9.25 min, SD=1 min 4 s) (p=0.019). Participants using WF-TSM were slightly slower than the CONTROL by 15 seconds on average (M=9.5 min, SD=49 s), though that difference was not significant. The difference between GP-TSM and WF-TSM, however, was still significant (p=0.003).

TABLE 3

| Question Statements | GP-TSM | WF-ISM | Control |
|---|---|---|---|
| How would you rate your overall experience in this interface? | 5.52 (1.45)*† | 4.1 (1.19) | 4.35 (1.32) |
| How mentally demanding was the task? (lower is better) | 3.98 (3.46)*† | 5.21 (3.48) | 5.13 (1.3) |
| How physically demanding was the task? (lower is better) | 1.93 (3.34) | 1.98 (3.54) | 1.85 (1.62) |
| How hurried or rushed was the pace of the task? (lower is better) | 3.13 (1.88) | 4.49 (1.91) | 4.35 (1.72) |
| How mecessful do you think you were in accomplishing the task? | 5.09 (1.37)* | 3.87 (1.56) | 4.61 (1.48) |
| How hard did you have to work to accomplish | 3.65 (1.16) *† | 4.97 (1.52) | 4.78 (1.43) |
| your level of performance? | | | |
| (lower is better) | | | |
| How insecure, discouraged, irritated, stressed, and annoyed | 2.32 (3.38)* | 4.57 (2.1) | 2.29 (1.31) |
| were you during the task? | | | |
| (lower is better) | | | |
| I could recognize the key points in the passage. | 6.16 (1.04)*† | 5.12 (1.13) | 5.23 (1.06) |
| I could recognize how the key points are supported by | 5.9 (1.09) | 4.98 (1.25) | 5.38 (1.46) |
| additional detail in the passage. | | | |
| The system's choice of what to gray out and | 5.91 (1.67)* | 2.38 (1.44) | N/A |
| what to keep at full font | | | |
| weight made sense to me. | | | |
| I think I know why certain words were lighter than others. | 5.36 (3.14)* | 4.83 (3.21) | N/A |
| I found it helpful that certain words were lighter than others. | 5.67 (3.81)* | 3.12 (3.33) | N/A |
| The different levels of gray helped | 5.19 (1.22)* | 2.41 (1.25) | N/A |
| me see the relationships between | | | |
| different parts of sentences. | | | |

Table 3 illustrates statistics of scores in the survey after each reading task. Participants were asked to rate their agreement with statements related to their reading experience on a 7-point Likert scale from “Strongly Disagree” (1) to “Strongly Agree” (7). Questions 2 through 7 (and their scales) were adapted from the NASA Task Load Index. Statistics in columns 2, 3, and 4 are presented in the form of mean (standard deviation). ANOVA analysis shows a significant main effect of Condition on participants' answers. Statistically significant (p<0.05) differences compared with _{WF-TSM} and _{CONTROL} are marked with * and †, respectively. For the last four statements, which concern the text opacity visualization and thus do not apply to the control condition, significance was calculated based on the two experimental conditions.

### Quantitative Survey Feedback.

Table 3 shows participants answers to questions asked immediately after each reading task, with some exceptions when the questions are irrelevant in a given condition. ANOVA analysis shows a significant main effect of Condition on their answers. Overall, participants generally expressed preference for GP-TSM over WF-TSM and CONTROL. Tukey's test shows that GP-TSM received significantly more positive ratings from participants than CONTROL in 4 out of the 9 questions that were asked in both conditions (p<0.05), for overall experience, how mentally demanding the task was in that condition, how hard they had to work in that condition, and recognizing key points in the passage. GP-TSM also received significantly more positive ratings from participants than WF-TSM in 6 out of the 9 questions that were asked in both conditions (p<0.05). These questions included all of the same questions that were significant for the GP-TSM-CONTROL comparison and additionally included how successful they thought they were and how insecure, discouraged, etc. they felt. Finally, in the questions which were only asked in the GP-TSM and WF-TSM conditions because they asked specifically about opacity modulation which was not present in CONTROL, GP-TSM received significantly better Likert scale ratings than WF-TSM for all 4 questions (last 4 rows of Table 3), which were all about the intelligibility of why certain words were less salient and their helpfulness, especially for seeing the relationships between different parts within sentences.

After experiencing all the conditions, participants were asked to rate their agreement on a 7-point scale (7 being the highest) with the following statement for each condition: “I would like to use [Condition] to read online text of interest to me in the future.” GP-TSM received a mean agreement score of 5.8 (SD=1.8) while CONTROL received a mean agreement score of 4.7 (SD=1.3) and WF-TSM received a mean agreement score of 3.3 (SD=2). This difference was significant between GP-TSM and both CONTROL and WF-TSM, respectively (<0□002) using additional pairwise unpaired t-tests.

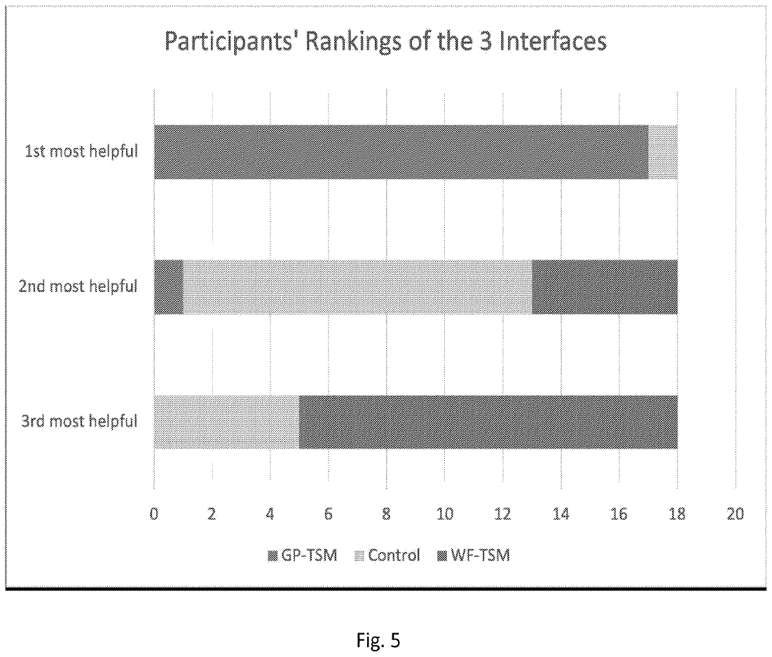

FIG. 5 is a graph illustrating user's ranking of the three exemplary implementations of the present disclosure, GP-TSM, control, and WF-TSM. After experiencing all the conditions, participants were also asked to directly rank conditions. The graph illustrates that participants expressed a strong preference for GP-TSM over WF-TSM and CONTROL as a first preference.
P2—“The words that were grayed out were words that I could easily skip over and ignore if I wanted to simply get the main idea of the passage. It made my reading faster and less congested, which helped a lot with my understanding of my passage.”
P7—“Words that I can skip are grayed out, so I read faster using [GP-TSM].”

It became clear that the graying made sense to people, with a lot of comments on how they agreed with what the system chose to gray:
P9—“The graying is pretty consistent and reasonable to me.”
P16—“I could skip the grayed out words entirely and it did not hurt my reading flow at all, which was nice.”

Participants also provided interesting reflections on how GP-TSM shaped their reading experience and facilitated a two-step reading process where they first skimmed the black words for a quick grasp of the gist and then went back to certain sections to read more details:
P6—“The interface almost allowed me to read the passage in two ways. One way was to read each word, regardless of color like normal. But, alternatively, if I just read the black text I got the crux of the argument with none of the additional filler.”
P10—“I was better able to search back through the text to find key words or ideas that related to the questions I was trying to find answers for. I felt that I could continuously read the bold words and they formed understandable sentences—or, I could read the entire sentence if I wanted.”
P17—“I could easily skim the text at first, and then go back to see the details later.”

Participants also commented on the text visualization itself, appreciating that the graying was “natural” (P11) and “not too much drama but provided just the right amount of contrast for engaging reading” (P14). Overall, users found that the system's design helped them focus on key points and read more efficiently (P1, P3, P7, P8, P16, P17) and were excited about its future prospect:
P11—“Is it a Chrome extension of something? I would want to use [GP-TSM] to read my history readings.”
P16—“More people should use it to read online in the future.”

Despite a broad preference for the GP-TSM interface, participants still offered several suggestions for improvement. A recurrent theme was the desire for more explicit guidance, which reveals that not all participants quickly and intuitively grokked what the levels of gray meant:
P2—“A prompt that explained why some words were grayed out could have been helpful.”
P12—“It would have helped to have a tutorial to understand why some text was more gray.”

Others offered legibility-related suggestions and requests for customization, e.g., about the visual attribute being modified:
P6—“Potentially an option to distinguish the levels of grayscale to entirely different colors (instead of shades of gray, could they just be RGB, or something)”
P16—“The lightest gray text was a bit difficult to read. I wish it could be a little darker.”
P12—“The text was too small and close together”
P14—“If possible, I'd like to see a A+/A− icon by the side, so I can enlarge the font which helps me reading the light gray transition words in between.”

P2 and P14 suggested more significant changes, including an option to hide the grayed-out words entirely (a feature previously supported by HITL-GP-TSM-INTERACTIVE) and a different graying scheme where transition words are not in gray:
P2—“I wish I could put away the grayed out words so I could just read the words in black.”
P14—“Certain transition words being in gray impedes my reading sometimes when I want to pick up the transition logic between 2 elements in a sentence, or between 2 sentences.”

GP-TSM vs. NGP-TSM: the comparison Interview. As described in Sec. 4.2, after completing all the reading tasks and reflecting on the three conditions of GP-TSM, WF-TSM, and CONTROL, all the participants looked at the same passage shown twice, side by side, rendered with GP-TSM and NGP-TSM—one enforcing grammaticality at every minimum level of opacity and the other not. Fifteen (15) out of all 18 participants perceived a difference between the grammar-preserving and non-grammar-preserving renderings, although some could not specify exactly what the difference was:
P2—“[GP-TSM] seems to gray out longer chunks of text, while [NGP-TSM] grays out a lot of single words.”
P11—“In [GP-TSM], the transition is much more natural. In [NGP-TSM], honestly, I don't understand why certain words are in gray.”
P17—“I actually didn't feel that much a difference, but I seemed to have an easier time reading in [GP-TSM].”

Many pointed out correctly that the difference lies in grammaticality, in one way or another:
P1—“When I read the sentences [in GP-TSM], I could just read the black words and the sentences still made sense.”
P7—“The black text [in GP-TSM] keeps the grammar of the passage.”
P9—“[NGP-TSM] grays out many articles, prepositions, and other determiners, while [GP-TSM] doesn't. I think those small words are necessary to have.”
P12—“If you skip the gray parts [in GP-TSM], the remaining sentence is still complete. Not the case for [NGP-TSM].”
P18—“[NGP-TSM] grays out a lot of ‘the’, ‘a’ and ‘to’, which is a little bit annoying to me. Those words may not carry much meaning, but they are still important to the structure of sentences.”

As for user preferences, all 15 who perceived the difference between the two interfaces preferred GP-TSM to NGP-TSM because they felt it enabled them to achieve better comprehension and higher reading efficiency:
P13—“I like [GP-TSM] better. It just makes more sense to me. When I skipped the gray parts I still understood everything.”
P16—“I prefer [GP-TSM] because I can completely skip words in gray here but [in NGP-TSM] I still have to read some of the gray text to understand what is going on.”

### DISCUSSION

These user studies demonstrate the benefits of Grammar-Preserving Text Saliency Modulation (GP-TSM) for English reading comprehension. Participants responded positively to the chosen visual text attribute to be modified (e.g., text opacity) and especially strongly to the strategy by which text opacity was modulated (e.g., nested grammatical subsets of sentences that revealed layers of detail around the core of each sentence). One participant had reservations about the lack of predicted importance that the backend recursive extractive summarization process often assigned to transition words; this is evidence that the design goal concerning participants' ability to notice and recover in situations when they disagree with an automated judgement has been fulfilled (e.g., “AI resilience”). In spite of that observation, which was possible due to GP-TSM's design, there was a general consensus that GP-TSM's choices about which sections to gray out was superior to WF-TSM, which is the nearest alternative method of text saliency modulation in the literature.

Notably, the impact of the grammaticality enforced within GP-TSM's backend workflow was clearly perceived by most users; it garnered attention and praise in interviews when participants could see GP-TSM side by side with its non-grammaticality-enforcing twin, NGP-TSM. Multiple measures suggest that GP-TSM enhances reading efficiency, overall user experience, and reduces the perceived difficulty of reading.

By far, the most compelling quantitative evidence are the gains in performance and decreases in task time when using GP-TSM, compared to the controls. Participant performance on standardized test questions is less subjective than self-reported efficacy, which can be affected by social and cognitive biases, such as the lab setting, wanting to please the researchers, or guessing the hypotheses. When the relative gains in efficiency are considered alongside findings from post-task surveys and qualitative feedback, there is strong evidence for GP-TSM as a visualization tool supports faster and improved reading comprehension for English readers.

The advantage of the GP-TSM technique is the change the visual saliency of words by adjusting their opacity that also preserves the integrity of the original text while empowering readers to choose their level of engagement with the material. The evidence indicates that all design goals were fulfilled. Reflecting on the user experience, an intriguing transformation in reading patterns emerged from the feedback. Many participants pointed out, in one way or another, a two-step reading process that GP-TSM interface seems to promote. Initially, readers focused on the darker, more salient text to grasp the primary narrative or theme of the passage. This ‘overview’ phrase of reading gave them a framework or scaffold of the content. Subsequently, they revisited the passage to focus on the grayed-out sections, which filled in details where the questions were asked or their interest was piqued. This sequence resonates with efficient content absorption strategies highlighted in speed reading literature, where readers first capture the gist and then delve deeper. The interface, therefore, may inadvertently facilitate this structured, layered reading approach, which might explain the improvement in reading efficiency and comprehension.

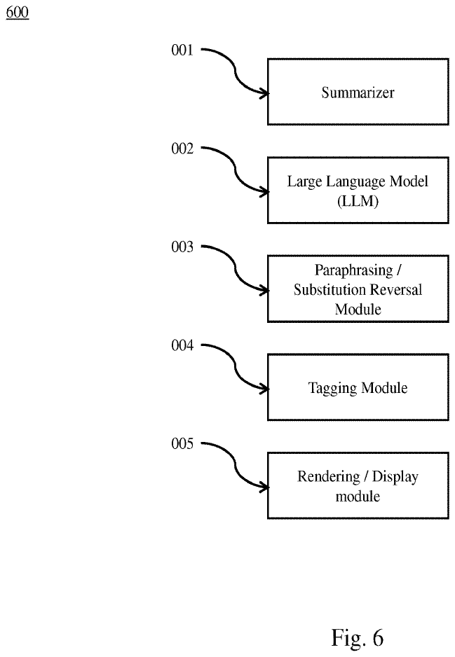

Referring now to FIG. 6, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices. In some embodiments, a non-exhaustive list of such program modules can include summarizer 001, large language model 002, paraphrasing/substitution reversal module 003, tagging module 004, and rendering/display module 005.

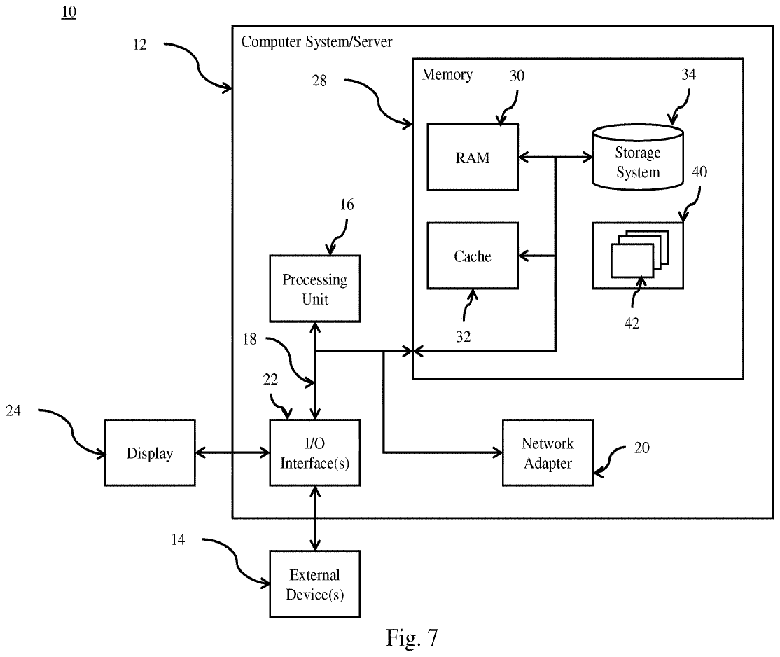

As shown in FIG. 7, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for saliency-based text display, comprising:
reading a source text comprising a plurality of tokens;
providing the source text to a summarizer, the summarizer configured to summarize input text;
receiving from the summarizer a first summarized text, the first summarized text being a summary of the source text;
providing the first summarized text to the summarizer;
receiving from the summarizer a second summarized text, the second summarized text being a summary of the first summarized text; and
tagging each token of the source text based on the first and second summarized texts, said tagging comprising:
applying a first tag to those tokens appearing in the source text but not the first or second summarized texts,
applying a second tag to those tokens appearing in the source text and the first summarized text but not in the second summarized text, and
applying a third tag to those tokens appearing in the source text, the first summarized text, and the second summarized text.

2. The method of claim 1, wherein the summarizer is an extractive summarizer.

3. The method of claim 1, wherein the summarizer is a stochastic summarizer.

4. The method of claim 3, further comprising providing a summarization instruction to the stochastic summarizer with the source text, with the first summarized text, and with the second summarized text.

5. The method of claim 1, wherein the summarizer comprises a large language model (LLM).

6. The method of claim 5, further comprising providing a summarization prompt to the LLM with the source text, with the first summarized text, and with the second summarized text.

7. The method of claim 5, further comprising providing a summarization prompt to the LLM with the source text to obtain a plurality of candidates for the first summarized text.

8. The method of claim 7, further comprising selecting the first summarized text from its plurality of candidates based on a quality score.

9. The method of claim 8, wherein the quality score is based on a grammatical correctness of each of the plurality of candidates.

10. The method of claim 8, wherein the quality score is based on a presence of paraphrasing and/or substitutions in each of the plurality of candidates.

11. The method of claim 8, wherein the quality score is based on semantic similarity between each of the plurality of candidates and the source text.

12. The method of claim 8, wherein the quality score is based on a length each of the plurality of candidates.

13. The method of claim 1, further comprising:
comparing the first summarized text to the source text to identify any tokens appearing in the first summarized text but not in the source text, and removing any such tokens from the first summarized text.

14. The method of claim 13, wherein removing such tokens comprises reversing any paraphrasing and/or term substitution created by the summarizer.

15. The method of claim 1, further comprising receiving a sequence of additional summarized texts from the summarizer, each summarized text in the sequence being based on its predecessor in the sequence.

16. The method of claim 15, further comprising terminating the sequence when a summarized text in the sequence is identical to its predecessor in the sequence.

17. The method of claim 15, further comprising terminating the sequence when a summarized text in the sequence has a quality score below a predetermined threshold.

18. The method of claim 17, wherein the quality score is based on grammatical correctness, presence of paraphrasing and/or substitutions, response length, or semantic similarity.

19. The method of claim 1, further comprising:
displaying the source text on a display, wherein each token in the source text includes a visual indicator of its associated tag.

20. The method of claim 19, wherein the visual indicator comprises one or more of:
highlight opacity, highlight color, font opacity, font hue, font size, font weight, font width, font style, typeface, case, or background color.

21. The method of claim 20, further comprising:
providing one or more interactive controls on the display, the one or more interactive controls operative by a user to update the visual indicator for the first, second, or third tag.

22. The method of claim 21, wherein the one or more interactive controls are operable to apply the visual indicator associated with the second tag to tokens having the first tag and/or to apply the visual indicator associate with the third tag to tokens having the first or second tag.

23. The method of claim 21, wherein the one or more interactive controls comprise on or more of: a slider or a natural language description.

24. A computer-implemented method for saliency-based text display, comprising:
reading a source text comprising a plurality of tokens;
providing the source text to a summarizer, the summarizer configured to summarize input text;
receiving from the summarizer a first summarized text, the first summarized text being a summary of the source text; and
tagging each token of the source text based on the first summarized text, said tagging comprising:
applying a first tag to those tokens appearing in the source text but not the first summarized text, and
applying a second tag to those tokens appearing in the source text and the first summarized text.

25. A computer program product for saliency-based text display, the computer program product comprising a computer readable storage medium having program instructions embodied therewith, the program instructions executable by a processor to cause the processor to perform a method comprising:
reading a source text comprising a plurality of tokens;
providing the source text to a summarizer, the summarizer configured to summarize input text;
receiving from the summarizer a first summarized text, the first summarized text being a summary of the source text;
providing the first summarized text to the summarizer;
receiving from the summarizer a second summarized text, the second summarized text being a summary of the first summarized text; and
tagging each token of the source text based on the first and second summarized texts, said tagging comprising:
applying a first tag to those tokens appearing in the source text but not the first or second summarized texts,
applying a second tag to those tokens appearing in the source text and the first summarized text but not in the second summarized text, and
applying a third tag to those tokens appearing in the source text, the first summarized text, and the second summarized text.
